(19) United States
(12) Patent Application Publication
(10) Pub. No.: US 2007/0267153 A1
(43) Pub. Date: Nov. 22, 2007

(54) Vertical Louvre Blinds

(75) Inventor: Stuart Hardy, Shropshire (GB)

Correspondence Address: O'SHEA, GETZ & KOSAKOWSKI, P.C., 1500 MAIN ST., SUITE 912, SPRINGFIELD, MA, 01115, US

(73) Assignee: Interior Solutions International Limited, Droitwich, Worcestershire (GB)

(21) Appl. No.: 10/586,804

(22) PCT Filed: Jan. 21, 2005
(86) PCT No.: PCT/GB05/00198

§ 371 Date: Jan. 2, 2007

(30) Foreign Application Priority Data
Jan. 21, 2004 (GB) 0401279.5

(51) Int. Cl. E06B 9/36

(52) U.S. Cl. 160/168.1 V

(57) ABSTRACT

A fitting for attaching a louvre and/or a voile to a hanger includes a one piece plastics moulding including two leaves, connected by a hinge moulded integrally between the two leaves. The leaves engage about a louvre and clips hold the leaves together to retain the louvre. A voile may be attached to the hanger using hook and loop fastener.

A vertical louvre blind installation typically comprises a headrail which supports and guides a plurality of hangers which, in turn, support a plurality of vertical louvres. The hangers are supported such that they can both move along the headrail and also rotate about a vertical axis so that the louvres may be drawn or rotated to control the amount of light entering a space. Typically a hanger comprises a hook which engages in an appropriate hole provided in the top of the louvre. A pelmet is sometimes provided around the headrail to hide the rail and the hangers.

It is now becoming common to hang voile over one or both faces of the louvres to give a more cosmetic appearance to the louvres. The voile is typically attached to the individual louvres by a hook and loop fastener, one part of the fastener being attached to the louvre the other to the voile.

Although voile is a relatively lightweight fabric, it may typically be used in lengths up to 4 times longer than the length of the headrail, and also have a drop of two meters or more. Accordingly it can place a significant additional load on the louvre. In particular, it may lead to even higher stresses in the louvre material at the point where the louvre is attached to its hanger. This may lead to the louvre ripping in this area, necessitating repair or replacement of the louvre.

The present invention seeks to overcome this problem, so from a first aspect there is provided a hanging fitting for a vertical louvre, said fitting comprising first means for supporting the louvre and second means for attaching a voile to the fitting.

Thus in accordance with the invention, both the voile and the louvre are supported by a common fitting through which both are attached to a hanger. This places less stress on the louvre, leading to prolonged louvre life. From a further aspect, therefore, the invention provides a vertical louvre blind comprising a hanging fitting for hanging from a head rail, a louvre blind mounted to the fitting and a voile mounted to the fitting.

Preferably, the voile attachment means is such as to allow the voile to be detached from the fitting, for cleaning for example. Preferably, therefore the attachment means comprises one or more releasable fasteners. These may comprise, for example, one or more press stud type fasteners. Most preferably, however, the attachment means comprises a hook and loop fastener. One part of the fastener will be provided on the fitting and the other on the voile. Most preferably the fastener is bonded to the fitting, for example being provided with an adhesive backing. In other arrangements, however, it may be preferable to provide a more substantial attachment. For example, when the blind is to be used in high temperature environments, adhesive may not provide a suitable attachment, losing its strength after prolonged exposure to heat. In such cases a mechanical attachment may be provided, for example the fastener being hot staked onto the fitting. Preferably the fitting is generally planar and the voile attachment means provided on one or both faces of the fitting.

Preferably the fitting comprises two parts which engage around the top of the louvre. In a particularly preferred embodiment the fitting comprises two leaves which sandwich the top of the louvre between them, preferably extending over the entire width of the louvre. This provides extremely good support for the louvre.

To facilitate assembly onto the louvre, the two pieces may be suitably hinged together. In the most preferred embodiment, the fitting is produced as a one piece plastics moulding with a living hinge moulded between the two parts.

It will be appreciated that such a construction can be used to hang louvres or voile individually so from a further aspect the invention provides a hanging fitting for a louvre or voile comprising a one piece plastics moulding comprising two parts, connected by a living hinge.

The fitting is preferably provided with means to attach it to a hanger. In a simple embodiment this may comprise an eye which is engaged by a hook or the like on the hanger.

In a particularly preferred embodiment, the fitting is provided with a recess in its upper end, and the louvre attachment means arranged in or adjacent the base of that recess. With such an arrangement the louvre hanger extends down into the recess so that the upper edge of the fitting may lie closer to the headrail. This may allow the pelmet to be dispensed with, as the hanger will be, to some extent, obscured by the fitting.

Preferably the voile attachment means is arranged such that the voile will extend across and cover the recess, thereby substantially obscuring the hanger from view. In one embodiment therefore, voile attachment means may be provided on either side of the recess. Most preferably voile attachment means is also provided below the recess so as to provide additional support for the voile.

The fitting may be attached to the louvre in any convenient manner. Preferably, however, it clips onto the top of the louvre. A separate clip may be used to effect the attachment, but preferably the clip is formed integrally with the fitting.

From a further aspect the invention provides a fitting for attaching a louvre to a hanger comprising two leaves for receiving the louvre between them and means for clipping the two leaves together to retain the louvre.

The fitting may hold the louvre through frictional engagement alone. Preferably, however, the fitting includes one or more posts which extend into openings provided in the louvre.

It will be appreciated that such a construction is advantageous in hanging louvres, even without voile, so from a further aspect the invention provides a fitting for attaching a louvre to a hanger comprising one or more posts for extending through a corresponding opening or openings in the louvre.

Preferably the or each post is at least in part arcuate or circular in section to avoid stress concentrations in the louvre. Most preferably there are two spaced apart posts.

In embodiments of the invention in which the fitting comprises two leaves, the post or posts may be formed on one leaf and extend into corresponding openings or recesses formed in the other leaf.

The voile may be provided with means to prevent it gaping around the fitting. To this end it may comprise fasteners positioned at suitable spacings along the top of the voile. The fastener could, for example, be a pad or the like of hook and loop fastener, or a pres stud type fastener.

This is also a novel arrangement so from a further aspect the invention provides a voile for attachment to a hanging fitting, said voile having releasable fastener means provided at spaced locations along its upper end to fasten opposed sections of voile together.

A preferred embodiment of the invention will now be described by way of example only with reference to the accompanying drawings in which:

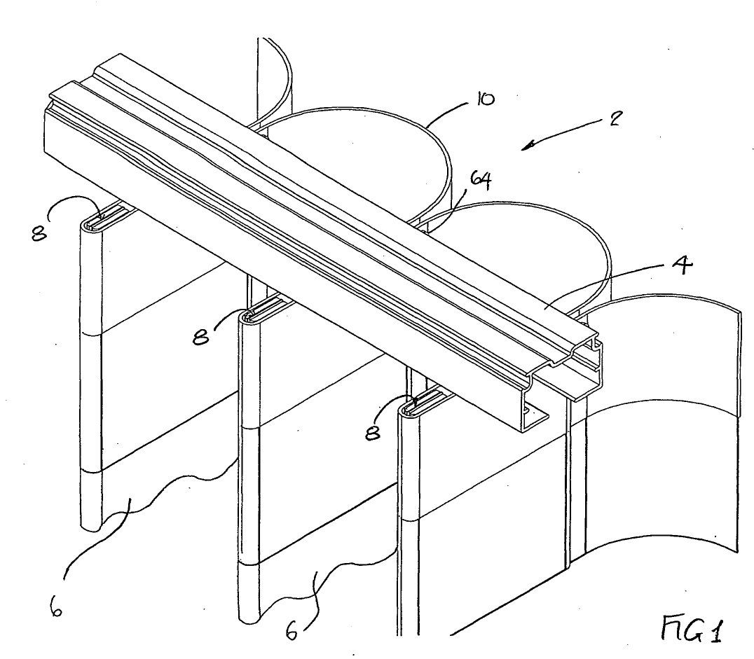

FIG. 1 shows a perspective view of a blind installation incorporating the invention;

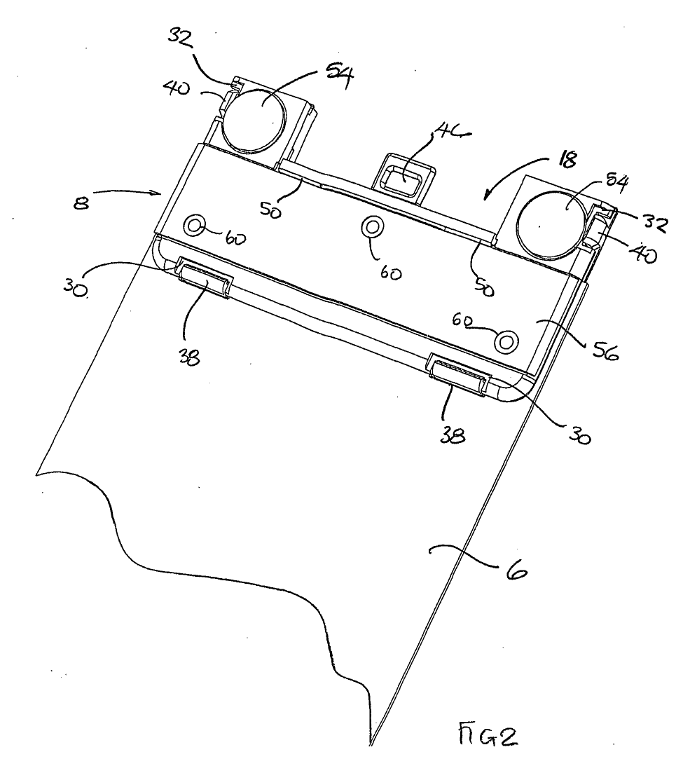

FIG. 2 shows a perspective view of the vertical louvre blind of FIG. 1;

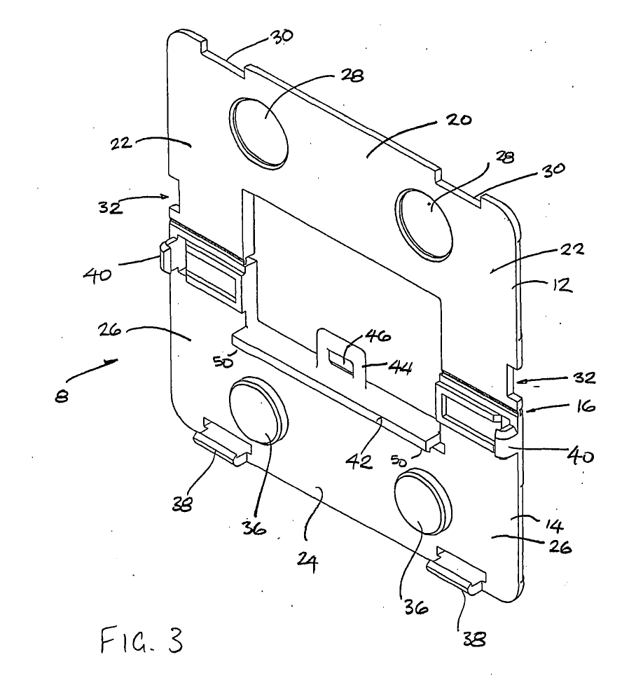

FIG. 3 shows the fitting of FIG. 2 in an open condition;

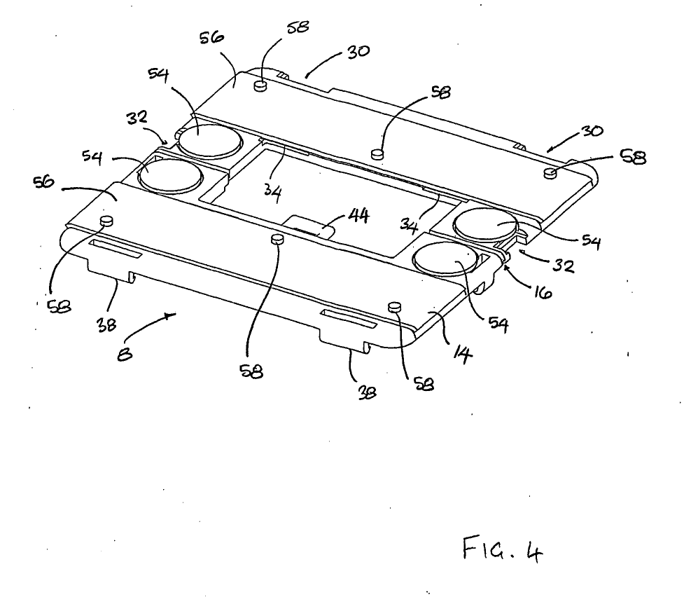

FIG. 4 shows the fitting of FIG. 3 from the rear,

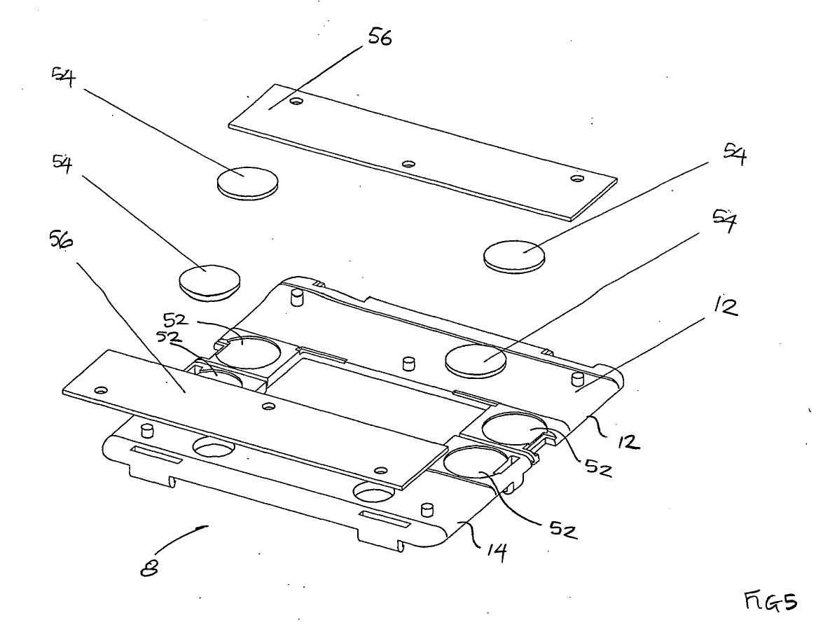

FIG. 5 shows the fitting of FIG. 4 with the fastener material removed; and

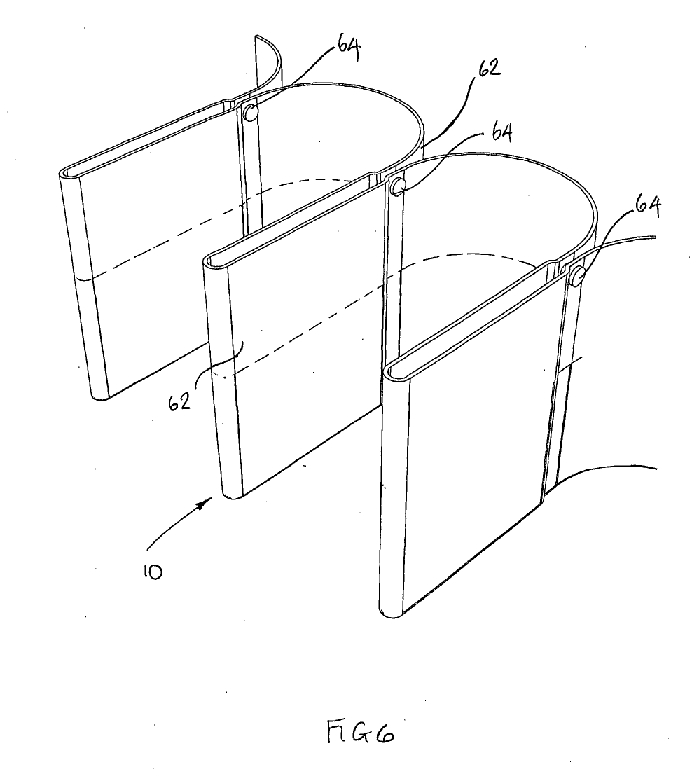

FIG. 6 shows the voile of the installation of FIG. 1 with the other parts remove for clarity.

With reference to FIG. 1, a blind installation 2 comprises a hanger rail 4 from which are suspended a plurality of vertical louvre blinds 6. The blinds are suspended by respective hanging fittings 8, which will be described further below. A length of voile 10 is wrapped around and attached to the fittings 8, as shown, to cover the gaps between the blinds 6.

The fitting 8 is a one piece plastics molding having a pair of leaves 12, 14, joined by a living hinge 16. Each leaf 12, 14 is generally U-shaped whereby a recess 18 is formed in the fitting 8 when the fitting is attached to the louvre 6, as shown in FIG. 2. The first leaf 12 thus comprises a main body portion 20 and a pair of side limbs 22 and the second leaf 14 comprises a main body portion 24 and side limbs 26.

The first leaf 12 also comprises a pair of circular recesses 28 which are spaced apart in the main body portion 20 of the leaf 12. It is also provided with a first pair of stepped slots 30 formed in the upper edge of the main body portion 20 and a second pair of stepped slots 32 defined in the edges of the side limbs 22. It also comprises a pair of grooves 34 in the lower edge of the main body portion 20.

The second leaf 14 comprises a pair of projecting posts 36 which, when the leaves 12, 14 are folded about the hinge 16, engage in the recesses 28 in the first leaf 12. The second leaf 14 is also formed with a pair of resilient clips 38 formed adjacent the edge of its main body portion 24 for engagement in the first slots 30 of the first leaf 12. The second leaf 14 also comprises a further pair of resilient clips 40 on its side limbs 26 for engagement with the second slots 32 of the first leaf 12.

The second leaf 14 further comprises a platform 42 from which projects a U-shaped member 44 which defines an eye 46 for receiving the hook of the louvre hanger. The free edge 48 of the platform 42 is formed with clip formations 50 which engage in the grooves 34 in the first leaf 12 when the leaves 12, 14 are folded together about the hinge 16.

With reference to FIGS. 4 and 5, the rear face of each side limb 22, 26 of the first and second leaves 12, 14 each comprises a shallow recess 52 which receives a pad 54 of a hook and loop fastener. The pads 54 are preferably formed with an adhesive backing to facilitate bonding into the recesses 52.

In addition to the circular pads 54 of hook and loop fastener, rectangular strips 56 of hook and loop fastener are bonded to the back of main bodies portions 20, 24 of the first and second leaves 12, 14. To facilitate proper location of the strips 56 on the hanger 8, the rear faces of the first and second leaves 12, 14, are provided with location pegs 58 which project through holes 60 provided in the strips 56. As shown in FIG. 5, the strip 56 covers the recessed rear faces 62 of the posts 36 of the second leaf 14.

In use, the pads 54 and strips 56 of fastener are attached to the fitting moulding shown, preferably before packaging or shipping the product. In addition to the adhesive backing holding the strips 56 in place, the pegs 58 are hot staked over the strip, as shown in FIG. 2, to provide three retaining flanges 60 on each strip.

The assembled fitting as shown in FIG. 4 is clipped over the top of a louvre 6 when required. The louvre 6 has circular openings (not shown) to receive the posts 36 of the fitting 8 and a pair of rectangular openings (not shown) to allow the passage of the clips 38 through the louvre 6. Thus, the louvre is positioned over the posts 36 and clips 38 and the first leaf 12 then folded around the hinge 16 until the clips 38, 40, 50 engage with their respective slots 30, 32, 34 to close and retain the fitting 8 on the louvre 6.

It will be seen from FIG. 2 that pads 54 of hook and loop fastener are positioned provided on either side of the recess 18 and a strip 56 of fastener below it. Hook and loop fastener may then be applied to the voile. 10 in appropriate positions to fasten to the pads 54 and strip 56 so as to suspend the voile 10 from the fitting 8 rather than from the louvre 6. In the preferred embodiment, a strip 62 of hook and loop fastener is attached, for example stitched, along the top of the voile 10 such that it faces the fastener pads 54 and strips 56 on the fitting. Typically the strip 60 will be 50 mm deep, so as to be able to engage both the pads 54 and the strips 56, but individual, less deep strips could equally be used.

Preferably the hook formation of the fastener is provided on the fitting 8 and the loop formation provided on the voile.

In addition to the above, press studs 64 are provided at spaced apart positions along the voile. These prevent the voile gaping at the fitting 8.

It will be seen that in use the voile 10 will extend across the recess 18 hiding the eye 46 and also at least a part of the hanger which engages with the eye 46. This allows the blind to be hung closer to the head rail 4, avoiding the need for a decorative pelmet.

It will be appreciated that various modifications may be made to the embodiment described above without departing from the scope of the invention. For instance, the fitting 8 may be attached to the louvre hanger by means other than the eye 46. For example the hanger may have means which clips to or is otherwise secured to a part of the fitting. Indeed the hanger may be made integrally with the fitting.

Also, the fitting 8 need not be constructed as a pair of hinged leaves 12, 14. The leaves could be separate, need not be hinged and could be joined together by other suitable fasteners. The fitting need not even comprise a pair of leaves. Any structure which has means for supporting both the louvre and the voile will fall within the scope of the invention.

Also, the pads 54 and strips 56 of fastener material could be attached to the fitting 8 by just heat staking, or by some other method.

Also, while the voile has been described as having press studs to prevent gaping, it could, for example, simply be provided with a hook or loop fastener part to fasten onto the strip 62 of hook or loop fastener attached to the top of the voile 10.

1. A fitting for attaching a louvre and/or a voile to a hanger comprising a one piece plastics moulding comprising two leaves, connected by a hinge moulded integrally between the two leaves.

2. A fitting as claimed in claim 1 comprising first means for supporting a louvre and second means far attaching a voile to the fitting.

3. (canceled)

4. A fitting as claimed in claim 2 wherein the voile attachment means allows the voile to be detached from the fitting.

5. A fitting as claimed in claim 4 wherein the voile attachment means comprises one or more releasable fasteners.

6. A fitting as claimed in claim 5 wherein the voile attachment means comprises at least one hook and loop fastener.

7. A fitting as claimed in claim 5, wherein the fastener is bonded to the fitting, preferably being provided with an adhesive backing.

8. A fitting as claimed in any of claim 2 wherein the fitting is generally planar and the voile attachment means is provided on one or both faces of the fitting.

9. A fitting as claimed in claim 1 wherein the fitting comprises two parts which engage around the top of the louvre.

10. A fitting as claimed in claim 9 wherein the fitting extends substantially over the entire width of the louvre.

11. A fitting as claimed in claim 9 wherein the said parts comprise leaves which sandwich the top of the louvre between them.

12. A fitting as claimed in claim 9 wherein the two parts are hinged together.

13. A fitting as claimed in claim 12 wherein the-fitting is a one piece plastics moulding with a hinge moulded integrally between the two parts.

14. A fitting as claimed in claim 1 further comprising means to attach it to a hanger.

15. A fitting as claimed in claim 14 wherein the hanger attachment means comprises an eye.

16. A fitting as claimed in claim 14 wherein the fitting is provided with a recess in its upper end, and the hanger attachment means is arranged in or adjacent the base of that recess.

17. A fitting as claimed in claim 16 wherein the voile attachment means is arranged such that the voile extends across, and covers, the recess.

18. A fitting as claimed in claim 17 wherein the voile attachment means is provided on either side of the recess.

19. A fitting as claimed in claim 18 wherein the voile attachment means is also provided below the recess.

20. A fitting as claimed in claim 1 further comprising clip means for attaching the fitting to the louvre.

21. A fitting as claimed in claim 20 wherein said clip means is formed integrally with the fitting.

22. A fitting as claimed in claim 1 comprising one or more posts which extend through openings provided in the louvre to support the louvre.

23. A fitting as claimed in claim 22 wherein the or each post is at least part circular in section to avoid stress concentrations in the louvre.

24. A fitting as claimed in claim 22 comprising two posts spaced apart.

25. A fitting for attaching a louvre to a hanger comprising a plurality of posts for extending through corresponding openings in the louvre to support the louvre.

26. (canceled)

27. (canceled)

28. (canceled)

29. A voile for attachment to a hanging fitting, said voile having releasable fastener means provided at spaced locations along its upper end to fasten opposed sections of voile together.

30. A fitting for attaching a louvre and/or a voile to a hanger comprising a one piece plastics moulding comprising two parts, connected by a living hinge.
